(19) United States
(12) Patent Application Publication
(10) Pub. No.: US 2026/0179439 A1
(43) Pub. Date: Jun. 25, 2026

(54) AUTOMATED CONFIGURATION OF A GAMING DEVICE USING MULTIPLE CONFIGURATION SCRIPTS GENERATED BASED ON A CURRENT CONFIGURATION OF THE GAMING DEVICE

(71) Applicant: IGT, Las Vegas, NV (US)

(72) Inventors: Dwayne R. Nelson, Las Vegas, NV (US); Yan Ha, Reno, NV (US); Paul Bolton, Reno, NV (US)

(21) Appl. No.: 18/987,627

(22) Filed: Dec. 19, 2024

(51) Int. Cl. G07F 17/32

(52) U.S. Cl. CPC G07F 17/3227

(57) ABSTRACT

Systems and methods that responsive to an occurrence of a configuration event, determine a current configuration of an electronic gaming machine, and generate, at least partially based on the current configuration of the electronic gaming machine, a plurality of configuration scripts associated with a plurality of automatic configurations of the electronic gaming machine. The systems and methods further cause a delivery of the generated plurality of configuration scripts.

### BACKGROUND

In various embodiments, responsive to an occurrence of a configuration event, the systems and methods of the present disclosure determine a current configuration of an electronic gaming machine, generate, at least partially based on the current configuration of the electronic gaming machine, a plurality of configuration scripts associated with a plurality of automatic configurations of the electronic gaming machine and cause a delivery of the generated plurality of configuration scripts.

Gaming machines may provide players awards in primary games. Gaming machines generally require the player to place or make a wager to activate the primary or base game. The award may be based on the player obtaining a winning symbol or symbol combination and on the amount of the wager.

### BRIEF DESCRIPTION OF THE FIGURES

FIG. 1A is a flow chart of an example process of an embodiment of procuring a generated configuration script to configure an electronic gaming machine.

FIG. 1B is a schematic diagram of an embodiment of the different factors a configuration script generator accounts for in generating a configuration script to configure an electronic gaming machine.

FIG. 1C is a schematic diagram of an embodiment of a user interfacing with a configuration script editor to access a game database utilized in the generation of a configuration script.

FIG. 1D is a flow chart of an example process of an embodiment of generating a configuration script to configure an electronic gaming machine.

FIG. 1E is a flow chart of an example process of an operator of an embodiment ordering a configuration script to configure an electronic gaming machine.

FIG. 1F is a flow chart of an example process of an embodiment of generating a configuration script based on the current configuration of an electronic gaming machine.

FIGS. 2A to 2D are example interfaces presented to an operator in association with building a configuration script to configure an electronic gaming machine.

FIG. 3A is a schematic diagram of an embodiment of the different components of a generated configuration script.

FIG. 3B is a schematic diagram of an embodiment of the different components of a generated configuration script packaged into a bundle with other software packages.

FIG. 3C is an example interface presented to an operator in association with choosing a game configuration to configure an electronic gaming machine.

FIGS. 3D and 3E are schematic diagrams of embodiments of a multiple layered configuration script and an operator choosing available options per level.

FIG. 4A is a flow chart of an example process of an embodiment of an operator applying a configuration script to configure an electronic gaming machine.

FIG. 4B is a flow chart of an example process of an embodiment of creating and applying a configuration script to configure an electronic gaming machine.

FIG. 4C is a flow chart of an example process of an embodiment of applying a configuration script to configure an electronic gaming machine.

FIG. 4D is a flow chart of an example process of an embodiment of applying a configuration script to configure an electronic gaming machine.

FIG. 4E is a flow chart of an example process of an embodiment of automatically applying a configuration script to configure an electronic gaming machine.

FIG. 5 is a schematic block diagram of one embodiment of an electronic configuration of an example electronic gaming machine of the present disclosure.

FIGS. 6A and 6B are perspective views of example alternative embodiments of an electronic gaming machine of the present disclosure.

FIG. 6C is a front view of an example personal gaming device of the present disclosure.

### DETAILED DESCRIPTION

In various embodiments, responsive to an occurrence of a configuration event, the systems and methods of the present disclosure determine a current configuration of an electronic gaming machine, generate, at least partially based on the current configuration of the electronic gaming machine, a plurality of configuration scripts associated with a plurality of automatic configurations of the electronic gaming machine and cause a delivery of the generated plurality of configuration scripts.

In certain embodiments, responsive to an occurrence of a configuration event associated with a gaming device, one or more components of the system operate individually or collectively to generate a configuration script to be executed by the gaming device. To generate the configuration script employable to automatically (or semi-automatically) configure a gaming device, the system employs one or more independently maintained data sets associated with one or more different entities to not only account for the current configuration of the gaming device but to do so in a manner that does not violate any preexisting requirements (and/or recommendations) from such entities and further does not result in any configuration errors of the gaming device. Put differently, in generating a configuration script, the system of the present disclosure accounts for one or more of any current configuration of the gaming device, the different available options of the gaming device, the rules and/or requirements of each game associated with the gaming device, any employed restrictions on any games or features of the gaming device, any inputs from an operator of the gaming device and/or any operational parameters from a supplier of the gaming device. For example, upon a request to modify a software package of an electronic gaming machine (“EGM”), a configuration script generator operates with a database that stores all available configuration options of all EGMs, applicable rules of all available games of such EGMs and EGM supplier recommended settings to determine and deliver a configuration script for that EGM. When executed by the EGM of this example, the configuration script not only accomplishes the requested modification of the EGM (without triggering any configuration errors) but does so while complying with the EGM supplier recommended settings for the particular gaming environment of the EGM.

In certain embodiments, the system of the present disclosure employs a configuration script generated by a gaming device supplier to completely (or partially) configure a gaming device while minimizing configuration errors and enforcing zero, one or more operational requirements for a respective gaming environment. In certain such embodiments, in configuring the gaming device, the system employs the generated configuration script to completely (or partially) limit the configuration options of a gaming device (to also minimize configuration errors and/or also enforce zero, one or more operational requirements for a respective gaming environment). In these embodiments, by accounting for different aspects of different entities (e.g., a gaming device supplier, a gaming device operator, and/or a gaming device regulator) as well as the different options available, the system of the present disclosure ensures that the generated configuration script, when executed, automatically (or semi-automatically) configures the gaming device based on different operational parameters designed to optimize performance while reducing (or eliminating) configuration errors that often occur due to the improper selection of different available options. As such, the configuration script generated by the system of the present disclosure enables one or more configuration software packages (i.e., the configurated script) to automatically configure the gaming device and/or one or more games of the gaming device in relatively complex scenarios when accounting for multiple technically divergent interests.

It should be appreciated that with the vast quantity of options made available to customize a gaming device, configuring that gaming device to optimize performance (or alternatively, to simply avoid configuration conflicts) has become a relatively complicated task. For example, in configuring an EGM, an operator may select from multiple different configurable game options, such as but not limited to, different denominations, different maximum wager amounts, different minimum wager amounts, different available languages, different double up options, and/or different progressive award options (e.g., different types of progressive awards, different contribution rates of the progressive award, different reset amounts of the progressive award and different maximum amounts of the progressive level). In this example, the operator may also select from multiple different configurable non-game options, such as, but not limited to, different operational settings with different remote hosts and how different available games appears in a game selection menu that enables a user to view and choose which available game of that EGM to play. As seen in this example, these different game and non-game options lead to a gaming device having dozens of configurable options which results in thousands of different configurations (e.g., twelve different true or false Boolean options leads to 2\hat{ }² (or 4,096) possible ways to configure a gaming device). Additionally, if such options are not Boolean, but rather selections from a listing of options (e.g., a listing of denominations to select from and/or a list of languages to select from), the quantity of available configurations of the gaming device only increases exponentially.

The thousands of possible ways to configure a gaming device and the software packages of that gaming device results in thousands of configurations of the gaming device that must be separately tested if each gaming device with each configuration were treated separately. However, in an effort to reduce the regulatory submission process for the different configurations available, gaming device suppliers generally offer a gaming device with one relatively highly configurable software package to all gaming device operators worldwide. Put differently, rather than separately configuring each gaming device for each gaming device operator based on the respective configuration request for a region and/or a gaming establishment, gaming device suppliers generally offer a gaming device with a single configurable game package that the gaming device operator or a field services technician of the gaming device supplier are tasked to configure for the respective gaming establishment.

However, requiring the operator or the field services technician of the gaming device supplier with the relatively complicated task of manually configuring the gaming device often leads to configuration errors, sub-optimal performance of the gaming device and/or the configuration of the gaming device not being in compliance with one or more operational guidelines of the gaming device supplier and/or the gaming device operator. In certain instances, since the configuration of one game available on a gaming device often drives which options should be selected for other games available on the gaming device, conflicting configurations may arise if the operator or the field services technician do not account for such requirements in configuring the gaming device. For example, if an EGM includes multiple installed games that are associated with a progressive award, to avoid a configuration error, the operator or the field services technician must configure each of these multiple games the same in accordance with the association with the progressive award. In certain other instances, since the available options of the gaming device must comply with certain platform configurations of the gaming device, conflicting configurations may arise if the operator or the field services technician do not account for such compliance in configuring the gaming device. For example, if a platform of an EGM is configured for a maximum wager amount of 250 credits for that EGM, then to avoid a configuration error, the operator or the field services technician must configure the maximum wager amount of all available games on the EGM to not exceed the 250 credit limit of the platform (even if the EGM provides the option of selecting one or more maximum wager amount configuration options that exceed 250 credits).

As seen by these examples, while offering a gaming device with a single configurable game package offers certain regulatory approval benefits and efficiencies for the gaming device supplier, such an offering potentially creates compatibility issues (i.e., many of the option combinations available from the single game package are not generally compatible with each other) for the operator and/or the field services technician of the gaming device supplier tasked with configuring the gaming device. To compound these issues, many of the option combinations available from a single game package are contrary to one or more operational parameters for a particular operator. For example, the configurable game package having selectable options pertaining to configuring a progressive award may be contrary to a gaming device operator, such as a casino, not wanting any EGMs to offer any progressive awards. Moreover, such a configurable single game package may offer options that are contrary to the operational parameters established by a supplier of the gaming device. For example, the supplier of an EGM may determine not to enable a particular gaming establishment to offer $0.01 denominations on poker games because the supplier of the EGM has determined that such a denomination results in suboptimal performance for the EGM placed at that particular gaming establishment.

Accordingly, given the competing interests of having a single configurable software package for gaming devices relative to the complexity associated with configuring the gaming device and certain preferred limits on the operational parameters of the gaming device, the system of certain embodiments of the present disclosure operates to automate (or semi-automate) the configuration of a gaming device while accounting for the current configuration of the gaming device and factoring in different requirements, recommendations and/or limitations on the operational parameters of the gaming device. In these embodiments, the system configures a gaming device and/or one or more games in a gaming environment via the employment of a configuration script controlled by a gaming device supplier and created to completely (or partially) configure the gaming device by eliminating configuration errors while enforcing gaming device supplier requirements (e.g., enabling/disabling progressive awards on certain gaming devices) and/or recommendations. The system of these embodiments additionally or alternatively limits the configuration of a gaming device and/or one or more games in a gaming environment via the employment of a configuration script controlled by the gaming device supplier and created to completely (or partially) limit certain configuration options of the gaming device to avoid configuration errors and enforce gaming device supplier requirements (e.g., limiting certain operators to certain denominations) and/or recommendations. Employing the current configuration of the gaming device and one or more independently maintained data sets associated with one or more different entities enables the gaming device to enter operation quicker (relative to prior gaming devices that often entered error states due to conflicting configurations selected the field services technician and/or the operator) while remaining in compliance with operational parameters and/or regulatory standards.

While certain embodiments described below are described as automating (or semi-automating) the configuration of an EGM (such as a slot machine, a video poker machine, a video lottery terminal, a terminal associated with an electronic table game, a terminal associated with a live table game, a video keno machine, a video bingo machine and/or a sports betting terminal that offers sports betting opportunities), it should be appreciated that such embodiments may additionally or alternatively be employed in association with automating (or semi-automating) the configuration of other devices, such as automating (or semi-automating) the configuration of a gaming application being executed by a mobile device, automating (or semi-automating) the configuration of a gaming establishment server (e.g., a server of a cashless ticket voucher system, a server of a gaming establishment patron management system, a server of a cashless wagering system, and/or a server that maintains one or more progressive awards), automating (or semi-automating) the configuration of a computing component of a gaming establishment management system associated with an EGM (e.g., a slot machine interface board in communication with an EGM) and/or automating (or semi-automating) the configuration of a non-gaming device, such as a kiosk (e.g., a cashless ticket voucher redemption kiosk) or non-gaming terminal (e.g., a gaming establishment retail point-of-sale terminal). It should further be appreciated that while certain embodiments pertain to the automatic configuration of an EGM (e.g., no user inputs received via any input devices are required to configure the EGM once the execution of the configuration script begins), other embodiments pertain to the semi-automatic (or partial automatic) configuration of an EGM (e.g., one or more user inputs, such as confirmation inputs, are received via one or more input devices to complete or otherwise facilitate the configuration of the EGM once the execution of the configuration script begins).

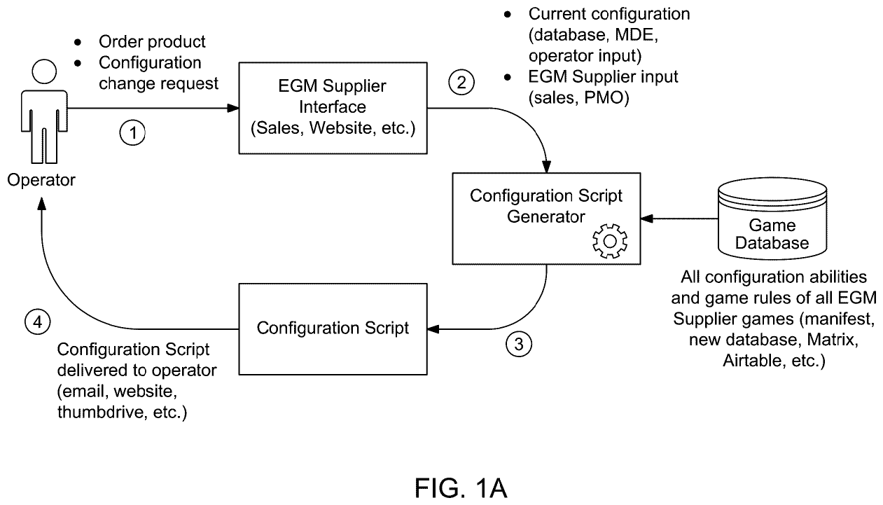

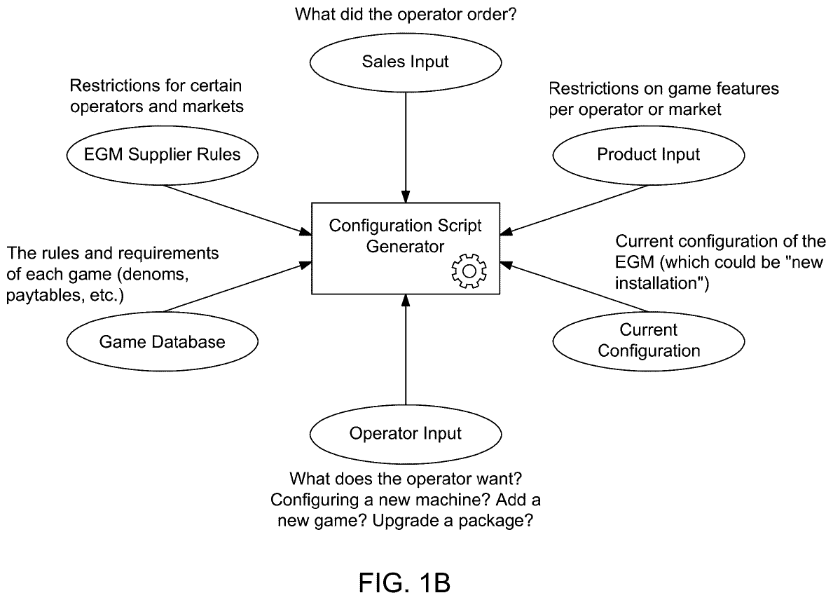

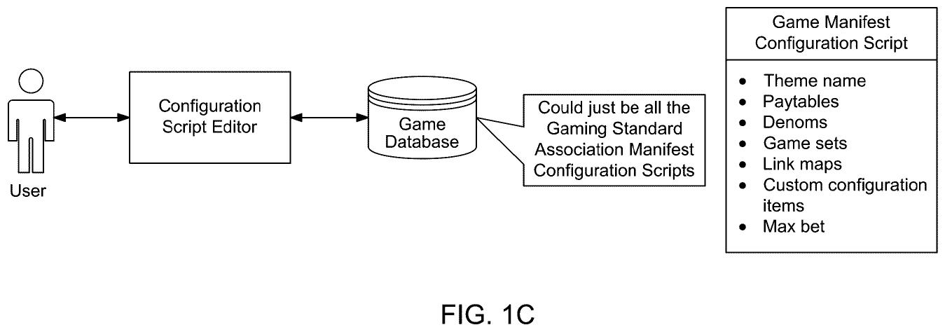

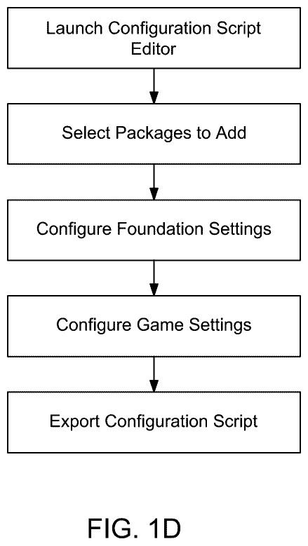

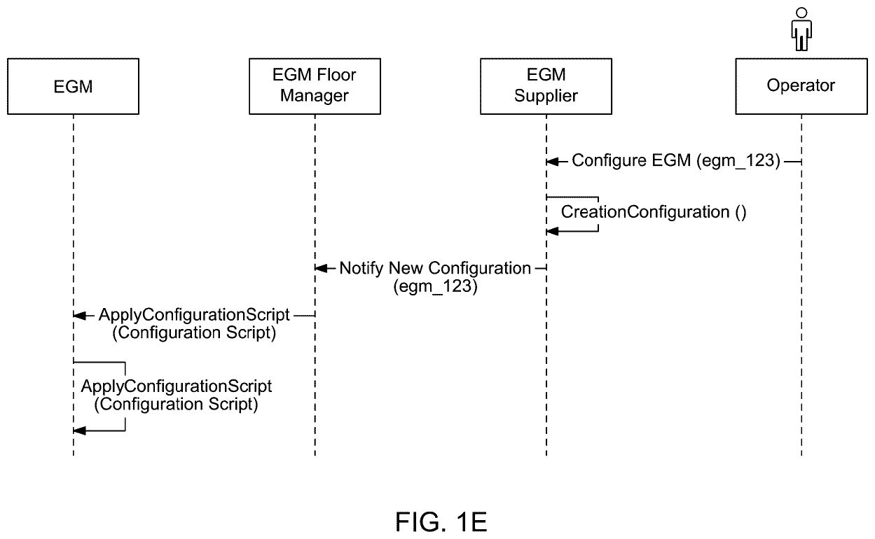

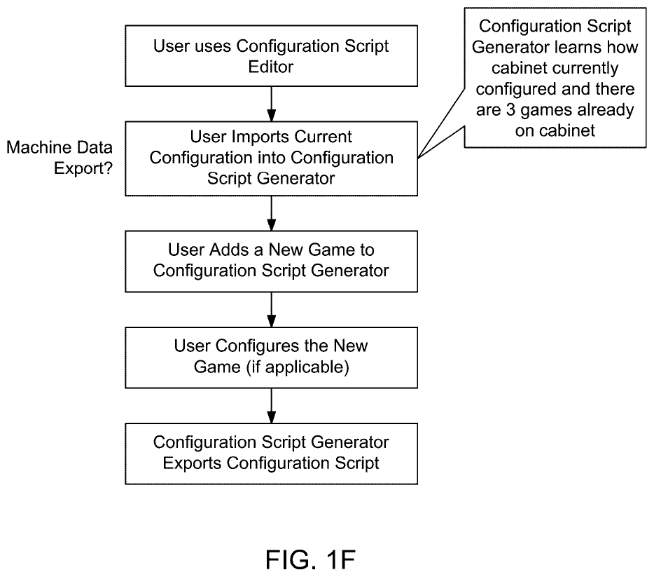

In operation of certain embodiments, following an occurrence of a configuration event, the system undertakes the generation of a configuration script (or configuration file) to effectuate the automatic (or semi-automatic) configuration of the EGM. In certain embodiments, the configuration event includes an operator ordering a new EGM via using a website or an application executed by a host system associated with an EGM supplier. In certain embodiments, the configuration event includes an operator ordering a requested modification of the configuration of an EGM (i.e., the configuration event is a reconfiguration event). In different embodiments, the system enables an operator to select different packages and/or options to be added to the configuration script in which the system oversees such selections to ensure that the different selections comply with various EGM supplier requirements (and/or recommendations), EGM operator requirements (and/or recommendations) and/or regulatory requirements (and/or recommendations) applicable for the EGM supplier, the operator and/or the regulatory environment which the EGM will operate in. For example, as seen in FIG. 1A, the system enables an operator to order a new EGM (or request a configuration change of an existing EGM) via an interface of the EGM supplier, such as via a website of the EGM supplier or a sales application associated with the EGM supplier.

In certain embodiments, following the configuration event, the system (and more specifically, in certain instances, one or more computing components of the EGM supplier) accepts the order for the configuration of the EGM and communicates order information to a configuration script generator. In certain embodiments, the configuration script generator is part of (or otherwise integrated with) the computing components of the EGM supplier, such as part of an EGM supplier ordering system. In certain embodiments, the configuration script generator is distinct from, but in communication with, the computing components of the EGM supplier, such as in communication with an EGM supplier ordering system.

In different embodiments, the configuration script generator employs different data sets from different sources to generate the configuration script. That is, the configuration script generator utilizes different inputs regarding, but not limited to, the current configuration of the EGM, prior configurations of the EGM, current configurations of other EGMs, prior configurations of other EGMs, configuration recommendations of the EGM from the EGM supplier, configuration requirements from the EGM supplier, configuration recommendations of the EGM from the EGM operator, configuration requirements from the EGM operator, configuration recommendations of the EGM from a gaming regulator, and/or configuration requirements from the gaming regulator to formulate the configuration script. For example, as seen in FIG. 1A, following the operator ordering the EGM (or requesting a configuration change of the EGM), a configuration script generator (i.e., a configuration script tool) utilizes various inputs from the EGM supplier (e.g., historical sales data) and the operator (e.g., a current configuration of the EGM) and certain data stored in a game database (e.g., data on configuration abilities and games of different EGMs), to generate a configuration script executable to modify the EGM.

Following the generation of the configuration script, the configuration script generator delivers the configuration script to the operator for execution. In different embodiments, the generated configuration script is delivered via an email, thumb drive, downloaded from a website, downloaded from an application, file share site and/or any suitable direct or indirect electronic communication from the configuration script generator. For example, as seen in FIG. 1A, the system delivers the generated configuration script to the operator for installation.

In certain embodiments, to enable enhanced interactions with operators, the system stores data regarding configuration script requests received from operators. In certain embodiments, to enable subsequent configuration scripts to be generated in light of prior generated configuration scripts, the system stores data regarding configuration scripts generated and delivered to operators.

In certain embodiments, the configuration script generator utilizes how one or more EGMs are configured as one of the inputs in generating the configuration script. In these embodiments, the configuration script generator includes or otherwise has access to one or more databases including data on how other EGMs from that EGM supplier are configured as well as different configurable options available for that EGM. For example, as seen in FIGS. 1B and 1C, the configuration script generator is in communication with a game database that includes data on each available game, how such games operate and any requirements of the EGM to execute such games. In this example, the game database includes information on the configuration rules and restrictions of each available game, such as, but not limited to, the permitted denominations of each game, the game set configuration of each game, the progressive award configuration of each game, and the language settings of each game. In different embodiments, the game database is any one or more of a database of existing game packages, a database of existing game manifest files (e.g., configuration files that detail various components of a game (such as symbols, reels, paylines, bonus rounds, and other gameplay features) that enable the game to be properly loaded and displayed on a gaming platform), a database with application data about one or more games, and/or a database configured to maintain game information for configuration script generations. It should be appreciated that in certain instances in which manifest files are automatically generated for every game, the configuration script generator accesses the database of manifest files in determining certain data associated with one or more games. However, since manifest files are designed for a host to install the game packages, over time the features of the configuration script generator may potentially require updates to the manifest database that are beyond the current capabilities of the manifest database.

In certain embodiments, the configuration script generator additionally or alternatively utilizes one or more operator inputs (e.g., operator inputted preferences) in generating the configuration script. In these embodiments, the configuration script generator receives data on any operator inputs or accesses one or more databases including data on any operator inputs. For example, as seen in FIG. 1B, the configuration script generator is in communication with a operator input database that includes data on any inputs received from the operator, such as what request is the operator making (e.g., is the operator ordering a new EGM, requesting an additional game to an EGM or upgrading a game package of an EGM).

In certain embodiments, the operator inputs include inputs made in association with the configuration event. In these embodiments, the system enables an operator to interface with one or more computing components of the EGM supplier to select different packages to be added to the configuration script in which the system accepts, rejects or modifies such selections to ensure that the generated configuration script complies with various EGM supplier requirements (and/or recommendations), EGM operator requirements (and/or recommendations) and/or regulatory requirements (and/or recommendations) applicable for the EGM supplier, the operator and/or the regulatory environment which the EGM will operate in.

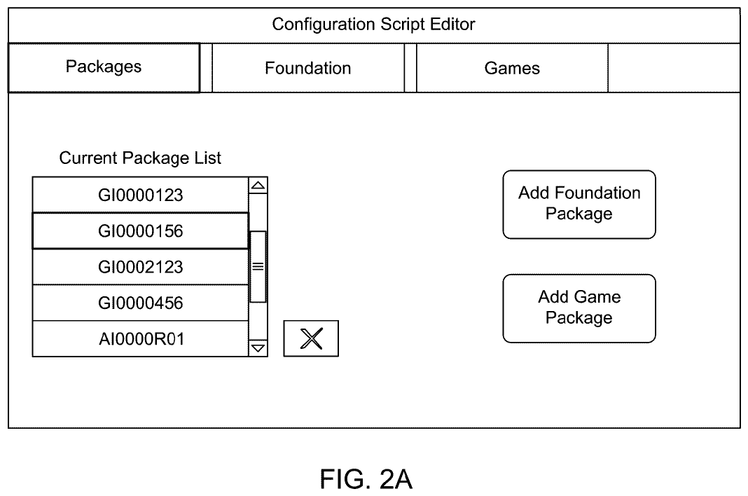

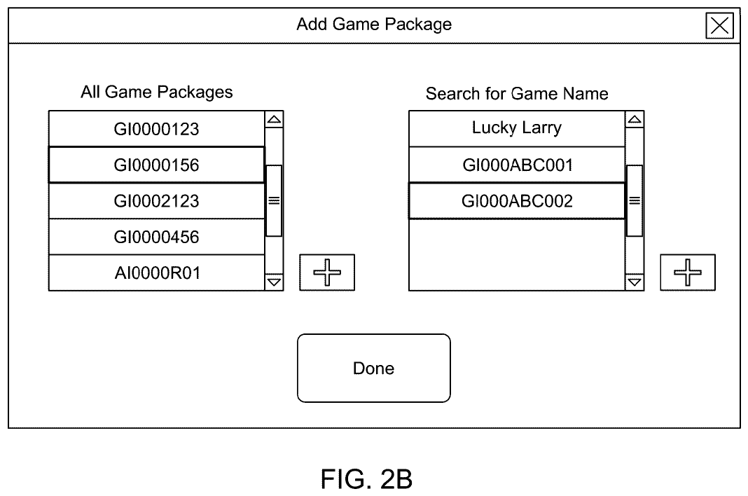

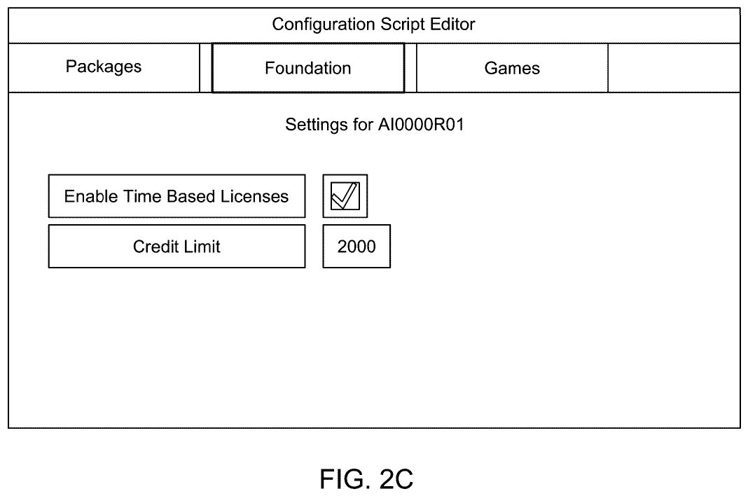

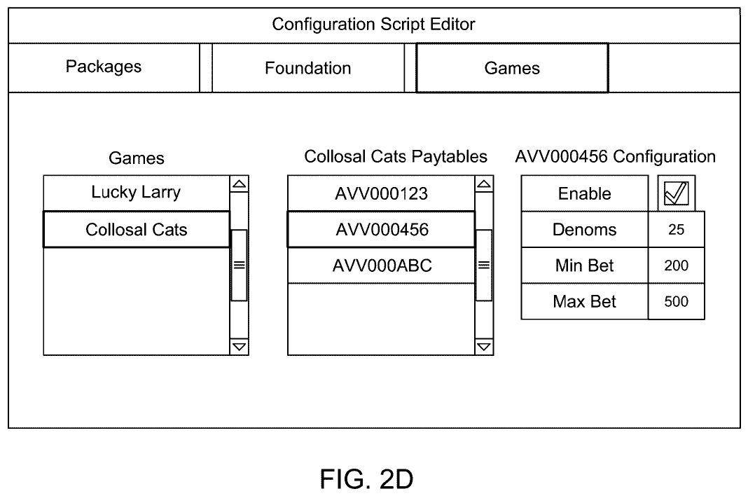

In certain embodiments, to receive one or more operator inputs, the system employs a configuration script editor to select zero, one or more EGM game packages (made available via the game database) to add to (or remove from) the configuration script; select zero, one or more EGM platform packages to add to (or remove from) the configuration script; configure zero, one or more settings of one or more selected EGM game packages (e.g., select a paytable, a denomination and bet values); and/or configure zero, one or more settings of one of more selected EGM platform packages. For example, as seen in FIG. 1D, the system enables an operator to access and launch a configuration script editor to select different packages to add to configuration script. In certain embodiments, the system employs one or more interfaces to enable the operator to make different inputs regarding one or more options of the EGM. For example, as seen in FIGS. 2A to 2D, the system enables an operator to interface with the configuration script editor to search for and add zero, one or more EGM platform packages, search for and add zero, one or more EGM game packages, and select certain settings.

In certain embodiments, to receive one or more operator inputs, the system employs an EGM supplier interface, such as a website of the EGM supplier to select zero, one or more EGM game packages (made available via the game database) to add to (or remove from) the configuration script; select zero, one or more EGM platform packages to add to (or remove from) the configuration script; configure zero, one or more settings of one or more selected EGM game packages (e.g., select a paytable, a denomination and bet values); and/or configure zero, one or more settings of one of more selected EGM platform packages. For example, as seen in FIG. 1E, the system enables an operator to utilize a website of the EGM suppliers to make one or more inputs in association with a requested configuration of an EGM. In this example, following the selections and the corresponding generation of a configuration script, as described in more detail below, the component of the EGM supplier delivers the configuration script to a configuration host system, such as an EGM floor manager, which operates to apply the configuration script to the EGM (to automatically or semi-automatically configure the EGM).

In certain embodiments, the operator inputs include inputs made independent of the configuration event. For example, a database stores data that Casino A uses a slot accounting system (“SAS”) ticketing system on every EGM such that the configuration script generator should automatically configure each EGM for Casino A to operate with such a ticketing system.

In certain embodiments, the configuration script generator additionally or alternatively utilizes one or more sales inputs in generating the configuration script. In these embodiments, the configuration script generator receives data on any sales inputs or accesses one or more databases including data on any sales inputs, such as inputs made in association with the operator specifying what they want that triggered the configuration event. For example, as seen in FIG. 1B, the configuration script generator is in communication with a sales input database that includes data on any sales inputs received from the operator, such as what did the operator order.

In certain embodiments, the configuration script generator additionally or alternatively utilizes one or more supplier inputs in generating the configuration script. In these embodiments, the configuration script generator receives data on any supplier inputs or accesses one or more databases including data on any supplier inputs, such as EGM supplier requirements and/or EGM supplier recommendations. In certain such embodiments, the configuration script generator includes logic, provided by the EGM supplier, on how to configure one or more EGMs per gaming establishment and/or per operator (e.g., the database includes an entry that indicates that Casino A should default to no progressive awards, while Casino B should always, when applicable, have all poker games in a progressive award configuration). For example, as seen in FIG. 1B, the configuration script generator is in communication with an EGM supplier database that includes data on any inputs received from the EGM supplier, such as which restrictions are in place for certain operators and/or in certain markets. Such inputs from the EGM supplier enables certain EGM supplier expertise to be automatically incorporated into the configuration of the EGM. That is, while an operator may prefer many different configuration options on an EGM, the operator may not be aware of how to actually configure the EGM to perform optimally. By integrating certain EGM supplier inputs into the automatic configuration of the EGM, the system enables the operator to have an EGM with a vast assortment of configuration options that still performs, based on the unique expertise of the EGM supplier, optimally in association with the use of that particular EGM.

In certain embodiments, the configuration script generator additionally or alternatively utilizes one or more product inputs in generating the configuration script. In these embodiments, the configuration script generator receives data on any product inputs or accesses one or more databases including data on any product inputs, such as product requirements and/or product recommendations. In certain such embodiments, the configuration script generator includes logic for one or more specific EGMs on any restrictions to how to configure that EGM (e.g. the database includes an entry that indicates certain restrictions per operator and/or market for one or more EGMs). For example, as seen in FIG. 1B, the configuration script generator is in communication with a product input database that includes data on any inputs received in association with an EGM, such as which restrictions to place on which games and/or features of an EGM for certain operators and/or in certain markets.

As evidenced by these embodiments, the configuration script generator employs significant EGM supplier knowledge, EGM operator knowledge, gaming knowledge, and regulatory knowledge received or accessed in determining one or more requirements, by operator and/or market, of one or more configuration scripts. Additionally, the configuration script generator employs significant EGM supplier knowledge, EGM operator knowledge, gaming knowledge, and regulatory knowledge received or accessed in determining one or more limitations, by operator and/or market, of one or more configuration scripts.

In certain embodiments, the configuration script generator additionally or alternatively utilizes one or more current configuration inputs in generating the configuration script. In these embodiments, the configuration script generator accepts the current configuration of the EGM as one input utilized to learn how the operator is currently using the EGM that the configuration script generator is tasked with reconfiguring. For example, as seen in FIG. 1B, the configuration script generator is in communication with a current configuration database that includes data on the current configuration of the EGM associated with the configuration event.

It should be appreciated that building a configuration script at least partially based on the current configuration of the EGM enables the automatic (or semi-automatic) configuration of that EGM while minimizing (or avoiding) configuration errors caused by conflicting configurations. That is, only by knowing everything on the EGM before adding, removing or updating a package can the system generate a configuration script that, when executed, provides a mechanism to configure every aspect of an EGM (effectively eliminating use cases where the EGM operator manually adds games) but does so in a way that does not present inconsistencies with existing software packages of the EGM. Put differently, by accounting for the current configuration of an EGM is the system of the present disclosure operable to automatically reconfigure that EGM without violating any retained configurations of the EGM and/or without erroneously retaining any configurations that result in operational defects of the EGM.

In certain such embodiments, the configuration script generator creates the configuration script for an EGM in association with accessing (and/or receiving) current configuration data of that EGM. Put differently, to add a game to an existing EGM, the configuration script generator accesses (and/or receives) data on which games are already on the EGM. In certain such embodiments, the configuration script generator receives data regarding the current configuration of the EGM (and/or any installed software packages) from one or more of a machine data export, a configuration export, a database that tracks the configuration of different EGMs (e.g., a database maintained by the EGM supplier) and/or a cloud-based managed service that enables operators to configure a gaming floor via real-time performance monitoring, skilled consultancy and remote cloud-based game downloads and configurations. In these embodiments, the machine data export and/or the configuration export enable an operator to export one or more current EGM configurations to a file that is then uploaded to the configuration script generator to at least partially facilitate the generation of the configuration script. For example, as seen in FIG. 1F, following a user, such as an operator, importing a current configuration of the EGM into the configuration script generator, and selecting zero, one or more new configurations (e.g., new games to be added and/or configurations of the new games), the configuration script generator generates, based on the current configuration of the EGM, the configuration script and exports the configuration script for execution on that EGM.

In certain embodiments, in building a configuration script, the configuration script generator uses one or more artificial intelligence predictive models to select one or more settings to be applied to the EGM to automatically (or semi-automatically) configure the EGM. In certain such embodiments, the system generates correlations between the data received or otherwise accessed by the configuration script generator and one or more configuration data clusters. The system then determines, based at least in part on the correlations, one or more configurations of the EGM to build into the configuration script. Put differently, the system employs a machine learning model (e.g., a large language model) or other artificial intelligence program to determine one or more ways to automatically (or semi-automatically) configure an EGM upon the application of a configuration script delivered to that EGM.

In certain embodiments, the generated configuration script includes various code and/or programs which the EGM utilizes to configure different operational aspects of the EGM. That is, since the software of the EGM is broken into multiple software packages with one or more game software packages (which each contain software on one or more games or game themes with a myriad configuration options on each) and a foundation software package (providing hardware abstraction, certain of the regulatory features and different configuration options (e.g., monetary limits, attract settings, and/or protocol settings) to enable the EGM to operate in various markets), the generated configuration script includes different sets of instructions to configure (or assist in the configuration) of different software packages having different roles in the operation of the EGM. As such, the generated configuration script enables the EGM to configure certain foundational software of the EGM as well as certain game software and non-game software of the EGM to ensure that the EGM operates in accordance with various EGM supplier requirements (and/or recommendations), EGM operator requirements (and/or recommendations) and/or regulatory requirements (and/or recommendations) applicable for the EGM supplier, the operator and/or the regulatory environment which the EGM will operate in.

Accordingly, in certain embodiments, the system of the present disclosure receives data associated with a request of a new software package to be installed on an EGM and determines a current configuration of the EGM. In these embodiments, the system generates, at least partially based on the current configuration of the EGM, a configuration script associated with the new software package, and causes a delivery of the generated configuration script. In certain other embodiments, the system of the present disclosure receives data associated with a requested modification of an EGM, and determines a current configuration of the EGM. In these embodiments, the system further generates, at least partially based on the current configuration of the EGM, a configuration script associated with the requested modification of the EGM, and causes a delivery of the generated configuration script. In such embodiments, when the generated configuration script is executed by a processor of the EGM, the generated configuration script automatically modifies the current configuration of the EGM.

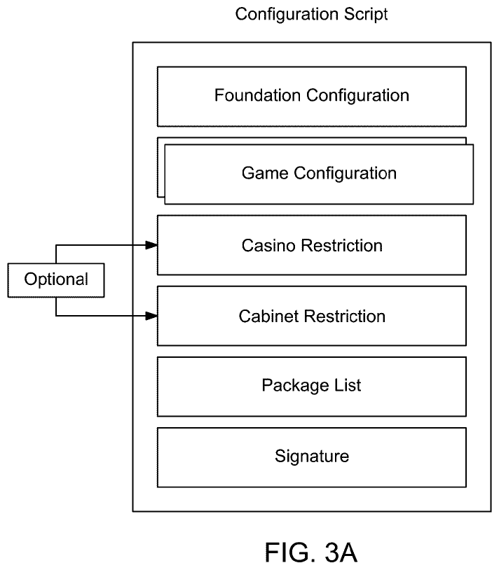

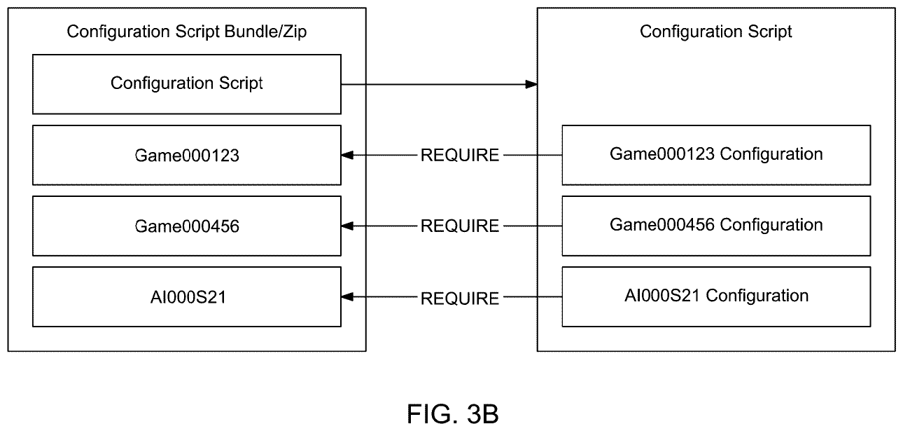

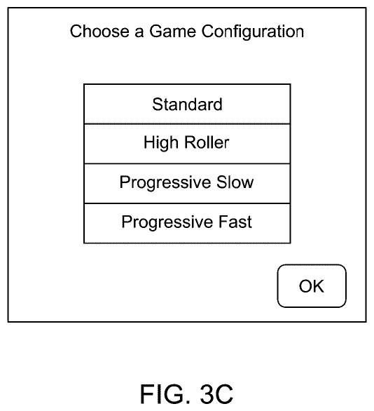

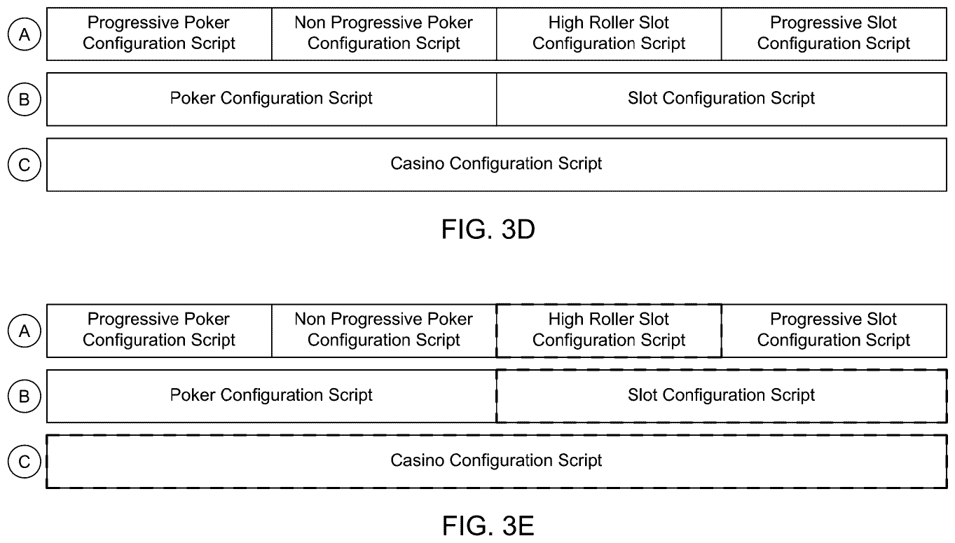

In certain embodiments, the generated configuration script includes one or more settings of the foundation software of the EGM. For example, as seen in FIG. 3A, the generated configuration script includes instructions on how to configure one or more of the operating system of the EGM and/or platform software of the EGM. In certain embodiments, the generated configuration script additionally or alternatively includes one or more settings of the game software of the EGM. For example, as also seen in FIG. 3A, the generated configuration script includes instructions on how to configure one or more games of the EGM.

In certain embodiments, the generated configuration script additionally or alternatively includes one or more settings pertaining to one or more gaming establishment restrictions (e.g., which gaming establishments (and/or operators) to which the generated configuration script applies). For example, as seen in FIG. 3A, the system enables a configuration script to be created with instructions that pertain to a specific gaming establishment. In certain embodiments, the generated configuration script additionally or alternatively includes one or more settings pertaining to which EGM(s), identified by unique identifier (e.g., serial number, asset number, MAC address of an Ethernet controller, CPU identifier), to which the generated configuration script applies. For example, the system enables a configuration script to be created specifically for EGM 12345678 at Casino B.

In certain embodiments, the generated configuration script additionally or alternatively includes one or more settings pertaining to restrictions on zero, one or more EGMs. For example, as seen in FIG. 3A, the system enables a configuration script to be created with instructions that pertain to an EGM restriction (e.g., if an EGM supplier limits the quantity of EGMs at Casino B having a denomination of $0.01 to five EGMs (because one or more computing components of the EGM supplier have determined that, based on the expertise of the EGM supplier inputted into the configuration script generator, Casino B will perform better with higher denomination EGMs), the generated configuration script includes instructions that when executed, operate with a database of EGM serial numbers (or other identifiers) per casino, to configure the EGM to remain in compliance with any EGM restrictions).

As illustrated by this example, it should be appreciated that in certain instances, the generated configuration script operates to configure an EGM by limiting one or more configuration options of the EGM. Put differently, in addition (or alternative) to employing a configuration script to automatically (or semi-automatically) configure different settings of the EGM, the configuration script automatically (or semi-automatically) limits some configuration abilities of the EGM operator. For example, for an EGM that supports denominations of $0.05, $0.25, $1.00 and $5.00, the configuration script sets the denomination of the EGM to $0.25 (i.e., configuring a setting) and disables the denomination of $5.00 (i.e., limiting a setting). In this example, since the configuration script is delivered to a specific casino with a certain demographic of customers and since the configuration script generator accesses one or more databases to determine that casinos with that certain demographic of customers routinely do not engage EGMs with $5.00 denomination games, the configuration script generator generates the configuration script with a denomination of $5.00 disabled.

In certain embodiments, the generated configuration script additionally or alternatively includes one or more signature files that authenticates the configuration script, such as by identifying that the configuration script came from an EGM supplier and can be trusted. In these embodiments, changing any information of the configuration script would invalidate the configuration script. In certain instances, such as seen in FIG. 3A, the signature is a part of the configuration script. In certain other instances, the signature is part of a second file that contains the signature associated with the configuration script.

In certain embodiments, the generated configuration script contains an expiration date. In these embodiments, if the configuration script expires, the configuration script will not work and the operator must obtain a new configuration script from the EGM supplier. In certain embodiments, the generated configuration script contains an activation date which is the date after which the configuration script may be used. In these embodiments, the activation date may be used to synchronize a configuration with a software release or a product launch.

In certain embodiments, the generated configuration script is encrypted for additional security. In certain such embodiments, to authenticate the generated configuration script, the EGM employs a hash function. For instance, before executing the generated configuration script, the EGM hashes the configuration script code using a stored hash function to obtain a result hash and compares the result hash to a stored authentication hash. If the result hash matches the authentication hash, the EGM determines that the configuration script is valid and the configuration script may be executed. If the result hash does not match the authentication hash, the EGM determines that the configuration script is invalid, such as if it has been altered (e.g., may have been tampered with) and prevents execution of the configuration script. Such a comparison of a certificate of the configuration script (i.e., the authentication hash) to a computed value of the configuration script (i.e., the result hash) enables the EGM to authenticate the configuration script and ensure its validity prior to execution. It should be appreciated that in certain instances, the authentication hash needs to be verified if it is signed with a private key of the software manufacturer. In these instances, the EGM uses the public key of the software manufacturer to verify the authentication hash, and if valid, proceeds with the comparison of the authentication hash value with the calculated hash value.

In certain embodiments, the generated configuration script is compressed. In certain such embodiments, the configuration script is packaged with all the software packages required to configure the EGM (which represents a valuable time saving measure). In these embodiments, the deliverable package is a zip file with the generated configuration script and the software packages (e.g., as seen in FIG. 3B, the package lists that it is configuration for Foundation AI000S21, Game GI0000123 and Game GI0000456). In certain embodiments, the deliverable package contains or describes one or more licenses for the software. In these embodiments, rather than maintaining EGM software separate from the licenses that enable the use of such EGM software, the system electronically delivers the licenses (e.g., over a network or via a USB drive) to the EGM. Such a configuration enables the deliverable to the EGM to contain one or more configurations to be applied, one or more software packages to be installed and one or more licenses.

In certain embodiments, the deliverable package contains one configuration script with one configuration of an EGM. In these embodiments, the single configuration script of the package describes a singular configuration of the EGM that, based on various inputs from various entities (e.g., the current configuration of the EGM, logic from the EGM supplier and/or requests from the EGM operator) complies with different operational parameters designed to optimize performance of that specific EGM while reducing (or eliminating) configuration errors that often occur due to the improper selection of different available options.

In certain embodiments, the deliverable package contains one configuration script with multiple configurations of an EGM. In these embodiments, the single configuration script of the package describes multiple configurations of the EGM that each, based on various inputs from various entities (e.g., the current configuration of the EGM, logic from the EGM supplier and/or requests from the EGM operator) comply with different operational parameters designed to optimize performance of that specific EGM while reducing (or eliminating) configuration errors that often occur due to the improper selection of different available options. In such embodiments, during the application process (described below), the EGM operator chooses which configuration to invoke/use from the configuration script. For example, as seen in FIG. 3C, following the system detecting that a configuration script includes configurations for a standard game configuration, a high-roller game configuration, a slow growth progressive award configuration and a fast growth progressive award configuration, the system prompts the EGM operator to pick which configuration to use.

In certain embodiments, the deliverable package contains multiple configuration scripts for a single EGM. In these embodiments, the system employs multiple configuration scripts to configure a single EGM. In certain such embodiments, the different configuration scripts have different uses and/or applicability for different EGM settings with certain configuration scripts being mandatorily applied and certain configuration scripts being optionally applied. For example, as seen in FIG. 3D, the system employs layered configuration scripts in which one configuration script (e.g., the casino script of Row A) is common to all EGMs and operates to configure elements and features common to all EGMs such as the ticketing settings, volume settings, monetary limit settings and host address settings. In this example, certain layers of configuration scripts provide multiple configuration options (e.g., the Poker Script of Row B enables settings pertaining to a poker game, such as a double up feature and a certain set of denominations, while the Slot Script of Row B enables settings pertaining to a slot game, such as disabling a double up feature and enabling a different set of denominations) and/or multiple game options (e.g., the game scripts of Row C). As seen in FIG. 3E, to configure the EGM, the EGM operator selects one configuration script to apply from each row to form a complete configuration that, based on various inputs from various entities (e.g., the current configuration of the EGM, logic from the EGM supplier and/or the inputs from the EGM operator) complies with different operational parameters designed to optimize performance of that specific EGM while reducing (or eliminating) configuration errors that often occur due to the improper selection of different available options.

In certain embodiments which employ layered configuration scripts, the system (and/or individual EGM) tracks the configuration scripts applied by layer and limits the application per layer. For example, if an EGM operator applies the Row B “Poker Script” of FIG. 3D to the EGM, then the system notes that a Row B configuration script has been applied and prevents the application of another configuration script from the same layer (e.g. the system prevents the application of the “Slot Script”). In certain embodiments which employ layered configuration scripts, the system (and/or individual EGM) will not proceed until configuration scripts are applied for all (or certain) layers. For example, the EGM will not configure the EGM until one configuration script of each layer is selected (or at least until one configuration script of certain layers are selected).

In certain embodiments, the system employs one or more configuration scripts to partially configure an EGM. For example, the system only applies the Casino Script of Row C of FIG. 3D across the gaming establishment floor but leaves each individual EGM for manual configuration for the remaining parameters of the layered configuration script of FIG. 3D. These embodiments represent a partially automatic configuration in which certain non-negotiable settings applicable for multiple EGMs are automatically configured and certain negotiable settings (that generally cannot cause configuration conflicts regardless of which settings are selected) are manually configured by the operator or the field services technician.

Accordingly, in certain embodiments, responsive to an occurrence of a configuration event, the system of the present disclosure determines a current configuration of an EGM, and generates, at least partially based on the current configuration of the EGM, a plurality of configuration scripts associated with a plurality of automatic configurations of the EGM. In these embodiments, the system then causes a delivery of the generated plurality of configuration scripts.

It should be appreciated that the system may employ any number of configuration scripts pertaining to any configurable settings (e.g., communication settings, monetary limit settings, progressive award settings, game settings and/or game type settings) to completely configure an EGM to ensure that the EGM operates in accordance with various EGM supplier requirements (and/or recommendations), EGM operator requirements (and/or recommendations) and/or regulatory requirements (and/or recommendations) applicable for the EGM supplier, the operator and/or the regulatory environment which the EGM will operate in.

In certain embodiments, following the delivery of one or more generated configuration scripts to the EGM, the system proceeds with applying the configuration script to the EGM (such that the configuration script automatically or semi-automatically configures the EGM with the settings and/or parameters of the configuration script).

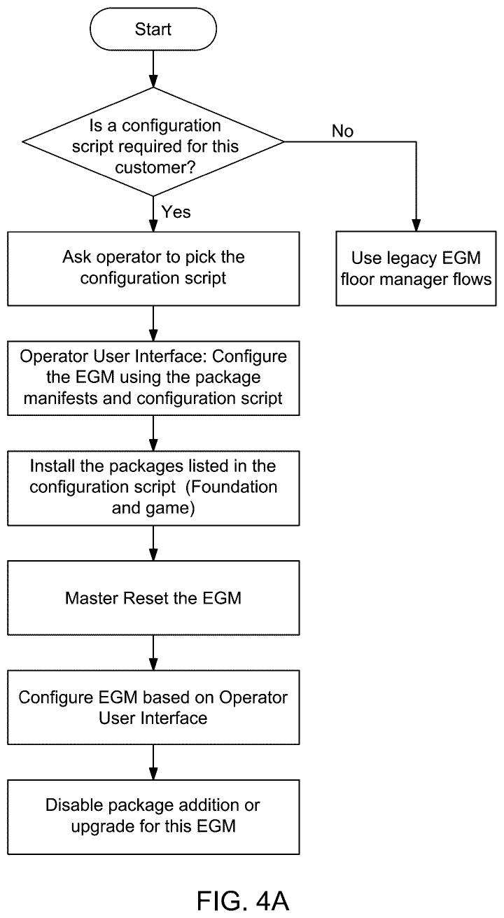

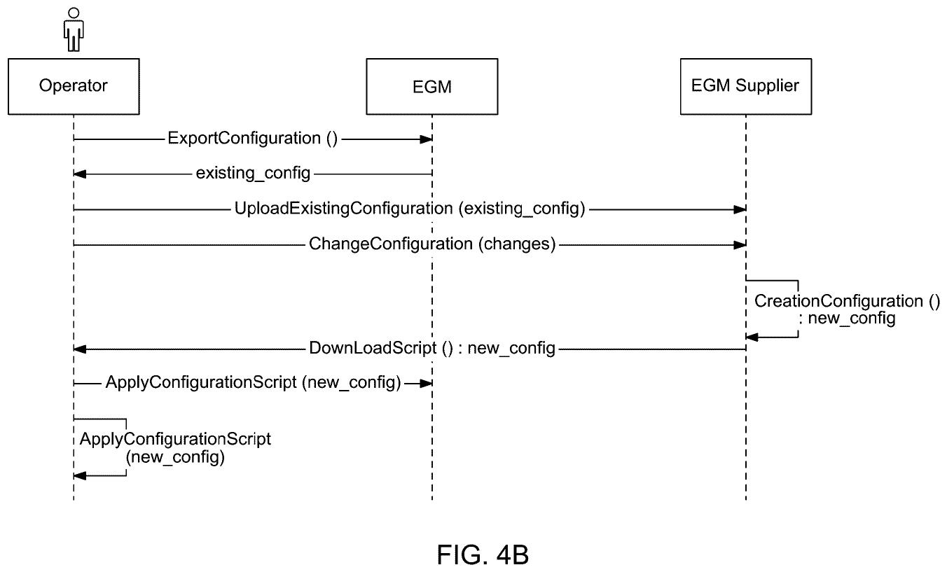

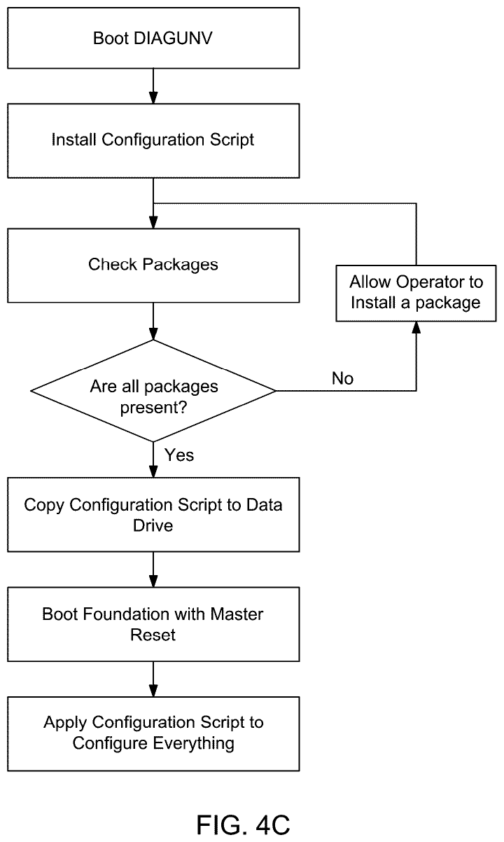

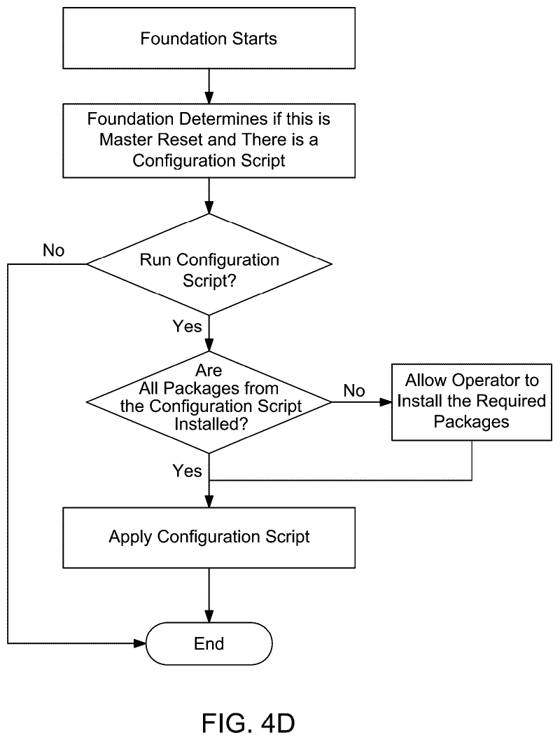

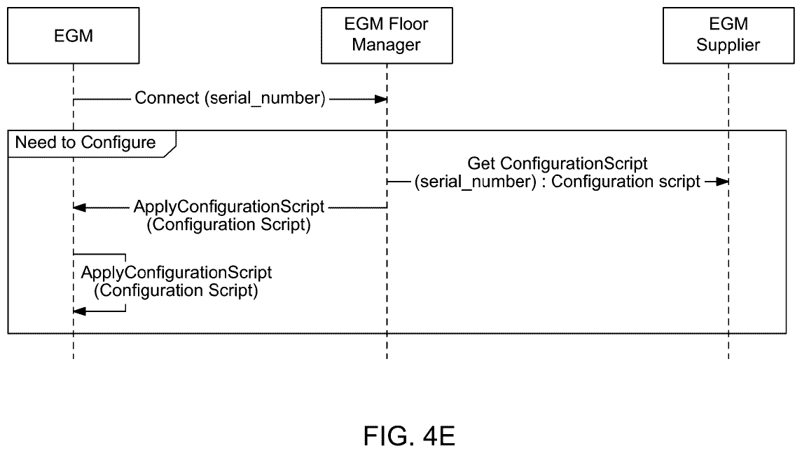

In certain embodiments, the system enables the operator to interface with the EGM to initiate the application of the configuration script to automatically (or semi-automatically) configure the EGM. In these embodiments, the operator (or the field services technician) manually applies the configuration script (which, once applied, automatically configures the EGM in accordance with the instructions of the generated configuration script). For example, as seen in FIG. 4A, following the determination that a configuration script is required in association with the configuration of EGMs for the operator, the system enables the operator to make one or more selections via an operator user interface. Such selections results in the installation of one or more software packages listed in the configuration script, and a master reset of the EGM (i.e., an operation where the EGM loses, with a few minor exceptions, all configuration settings of all software packages to return the EGM to a reset state ready to be configured). Following the master reset, the configuration script automatically configures the EGM and disables any configuration additions, upgrades or removals of the EGM.

In certain embodiments, such as seen in FIG. 4A, the application of the configuration script to the EGM applies a master reset of the EGM. Such embodiments enable the configuration script to configure the EGM relatively simply because configuration script is aware of default settings, if any, of the reset state of the EGM and thus can relatively easily determine which settings need to be configured coming out of the reset state.

In certain embodiments, the application of the configuration script to the EGM applies without any master reset of the EGM. In these embodiments, since the configuration script needs to be aware of the current configuration of the EGM (to properly determine which settings needs to be maintained and which settings needs to be changed), as described above, the system uploads data associated with the current configuration of the EGM to the configuration script generator when ordering a new game for the EGM and/or requesting a change of the EGM such that the configuration script generator accounts for the current configuration of the EGM while creating the configuration script used to configure the EGM. For example, as seen in FIG. 4B (which illustrates the interactions between a computing component, such as a server, associated with an EGM operator, an EGM and a computing component, such as a server, associated with an EGM supplier), the computing component associated with the EGM supplier obtains the current configuration of the EGM (such as by gaming personnel of the EGM operator visiting the EGM and exporting the current configuration to a USB drive which is then communicated to the computing component associated with the EGM supplier; by causing the EGM to export the current configuration to a computing component of a configuration host system (e.g., an EGM floor manager) which then communicates the current configuration to the computing component associated with the EGM supplier; or by causing the EGM to communicate the current configuration directly to the computing component associated with the EGM supplier). Following obtaining the current configuration of the EGM, an interface of the EGM supplier, such as a website, enables the EGM operator to input any adjustments, after which the computing component associated with the EGM supplier, such as the configuration script generator, generates the configuration script, and delivers the configuration script for application to the EGM.

In certain embodiments, the operator employs one or more tools to install software, such as the delivered configuration script, of the EGM. In certain cases, the operator employs a DIAGUNV tool in which the operator boots the EGM using the DIAGUNV tool on a USB thumb drive and then inserts various USB drives into the EGM and instructs the DIAGUNV tool to install the packages on the EGM. In certain embodiments employing a bundle approach in which the configuration script contains one or more software packages, the operator uses the DIAGUNV tool and applies the bundle. In these embodiments, since the bundle contains everything needed to configure the EGM, the automatic (or semi-automatic) configuration of the EGM proceeds in a relatively simple single operational step.

Accordingly, in certain embodiments, the system of the present disclosure receives data associated with a request of a software package installable on an EGM, and generates a configuration script associated with the software package. In these embodiments, the system then bundles the generated configuration script and the software package, and causes a delivery of the bundle to the EGM. Such a configuration eliminates known issues with partially configured EGMs because the delivered bundle includes all the software packages (and other files, such as configuration scripts and/or licenses) needed for installation.

It should be appreciated while certain cases employ the bundle approach to installing software on the EGM and automatically (or semi-automatically) configuring the software, other cases do not employ such a bundle approach. In these cases, as seen in FIG. 4C, the DIAGUNV tool determines which packages are required and prompts the operator to provide all those packages (which could be a frustrating step if the operator is expected to find USB drives that contain each of the packages described in the configuration script) before applying an ultimate master reset and applying the configuration script to configure each of the settings of the EGM. In certain embodiments, with or without the employment of any bundles, the DIAGUNV tool copies the configuration script to the data drive of the EGM foundation platform. In these embodiments, as seen in FIG. 4D, when the foundation platform is rebooted, the foundation platform locates the configuration script and applies the configuration script to the EGM.

In certain embodiments, one or more host systems install and/or cause the application of the software packages of the configuration script to automatically (or semi-automatically) configure the EGM. In certain embodiments, the host system is associated with the EGM supplier which operates directly or indirectly with the EGM to deliver the generated configuration script and cause the application of the generated configuration script to automatically (or semi-automatically) configure the settings of the EGM.

In certain embodiments, the host system is associated with the EGM operator which receives, directly or indirectly, the generated configuration script from a computing component associated with the EGM supplier and operates, directly or indirectly, with the EGM to cause the application of the generated configuration script to automatically (or semi-automatically) configure the settings of the EGM. For example, as seen in FIG. 4E, when an EGM connects to a configuration host system associated with an EGM operator, such as an EGM floor manager of a gaming establishment, the configuration host system determines if the EGM needs to be configured (e.g., is the EGM indicating it lacks a proper configuration). In these embodiments, the configuration host system associated with the EGM operator queries a computing component associated with the EGM supplier to learn the configuration the EGM. For example, since the EGM provided a unique identifier (e.g., a serial number learned from an operator input, a chip or other hardware that is programmed with the serial number at the time of manufacture) to the configuration host system associated with the EGM operator, the computing component associated with the EGM supplier uses that unique identifier to look up the current configuration of the EGM.

In certain embodiments, after learning the configuration of the EGM, the computing component associated with the EGM supplier delivers a configuration script generated by the configuration script generator (which may be part of or separate from the computing component associated with the EGM supplier) to the configuration host system associated with the EGM operator to apply to the EGM (to facilitate the configuration of the EGM). In certain other embodiments, after learning the configuration of the EGM, the computing component associated with the EGM supplier delivers a configuration script generated by the configuration script generator to the configuration host system associated with the EGM operator which compares the current configuration of the EGM with the received configuration script and applies the configuration script (to facilitate the configuration of the EGM) if the configuration host system associated with the EGM operator determines a difference. In certain other embodiments, after learning the configuration of the EGM, the computing component associated with the EGM supplier delivers a configuration script generated by the configuration script generator to the configuration host system associated with the EGM operator which enables the EGM to compare the current configuration of the EGM with the received configuration script and applies the configuration script (to facilitate the configuration of the EGM) if the EGM determines a difference.

Accordingly, in certain embodiment, the system of the present disclosure enables one or more (or each) EGM to be properly configured by, following a request for configuration data associated with an EGM, receiving a configuration script associated with the EGM. In these embodiments, responsive to an occurrence of a configuration event, the system causes an application of the configuration script to automatically configure the EGM. Put differently, certain embodiments of the present disclosure pertain to an EGM that communicates first configuration data to a component of a gaming establishment management system, and responsive to a determination that the first configuration data is different from second configuration data maintained by a component of an EGM supplier, receives a configuration script, and responsive to an occurrence of a configuration event, applies the configuration script to modify the first configuration data to the second configuration data.

It should be appreciated that in addition to automatically (or semi-automatically) configuring an EGM to ensure that the EGM operates in accordance with various EGM supplier requirements (and/or recommendations), EGM operator requirements (and/or recommendations) and/or regulatory requirements (and/or recommendations) applicable for the EGM supplier, the operator and/or the regulatory environment which the EGM will operate in, the system utilizes the configuration script to detect operational discrepancies of the EGM.

In certain embodiments, the EGM tracks if the EGM operator has applied a configuration script, but then later changed the configuration from the configuration script. That is, if the EGM supplier provided an EGM with preferred configurations (as configured via the application of the configuration script) to an operator but the operator deviated from the recommendations provided by the configuration script (i.e., a configuration deviation event occurred), the EGM supplier is informed of that information and may use it for determining operator support. For example, an EGM operator applies a configuration script that automatically configures a progressive award for a 2% contribution rate. In this example, if the operator later enters an operator menu of the EGM and confirms that they want to change the progressive award contribution rate from the scripted configuration of 2% to 3%, the EGM records the operator's decision, reports the operator's decision to a computing component associated with the EGM supplier and enables the operator to change the configuration. In this example, if the operator later contacts the EGM supplier to learn why the EGM is underperforming, the EGM supplier can observe that the operator deviated from the configuration of the configuration script (which may be displayed on one or more EGM displays and/or displays of the host system) and can recommend the operator return to the preferred configuration as determined in accordance with the configuration script.

In certain embodiments, the computing component of the EGM operator tracks if the EGM operator has applied a configuration script, but then later changed the configuration from the configuration script. That is, if the EGM supplier provided an EGM with preferred configurations (as configured via the application of the configuration script) to an operator but the operator deviated from the recommendations provided by the configuration script, such deviations are reportable to the EGM supplier for future operator support.

In certain embodiments, if the EGM malfunctions and/or has an operational problem, the EGM determines if the operator deviated from the scripted configuration as determined in accordance with the configuration script. In certain of these embodiments, the EGM suggests to the operator to return to the scripted configuration as determined in accordance with the configuration script. In certain other embodiments, upon determining a malfunction and/or operational problem, the EGM automatically switches the scripted configuration as determined in accordance with the configuration script.

In certain embodiments, if the EGM malfunctions and/or has an operational problem, the computing component of the EGM operator determines if the operator deviated from the scripted configuration as determined in accordance with the configuration script. In certain of these embodiments, the computing component of the EGM operator suggests to the operator to return to the scripted configuration as determined in accordance with the configuration script. In certain other embodiments, upon determining a malfunction and/or operational problem, the computing component of the EGM operator instructs the EGM to automatically switch the scripted configuration as determined in accordance with the configuration script.

Accordingly, in certain embodiments and responsive to a triggering event (e.g., an operational error of the EGM, an input received and/or an underperformance determination of the EGM), the system of the present disclosure determines a current configuration of a software package of an EGM, and determines a configuration of the software package associated with an applied configuration script. In these embodiments, responsive to the determined current configuration of the software package of the EGM being different from the determined configuration of the software package associated with the applied configuration script, the system causes a configuration deviation event to occur.

As such, the system of the present disclosure employs a configuration script generated by a configuration script generator, such as a configuration script generator associated with an EGM supplier, to completely (or partially) configure an EGM and/or limit the configuration options of the EGM while minimizing configuration errors and enforcing zero, one or more operational requirements of a respective gaming environment. By accounting for different aspects of different entities as well as the different options available, the system of the present disclosure ensures that the generated configuration script, when executed, automatically (or semi-automatically) configures, based on different operational parameters designed to optimize performance, the EGM while reducing (or eliminating) certain errors that occur due to the improper selection of different available options. As such, the configuration script generated by the system of the present disclosure operates to automatically (or semi-automatically) configure the EGM and/or one or more games of the EGM in relatively complex scenarios when accounting for multiple technically divergent interests.

Accordingly, given the competing interests of having a single configurable software package for EGMs relative to the complexity associated with configuring the EGM and certain limits on the operational parameters of the EGM, the system of certain embodiments of the present disclosure operates to at least partially automate the configuration of an EGM while factoring in different limits on the operational parameters of the EGM. In these embodiments, the system configures an EGM and/or one or more games in a gaming environment via the employment of a configuration script (in certain instances controlled by an EGM supplier) created to completely (or partially) configure the EGM by eliminating configuration errors while at least enforcing EGM supplier requirements, EGM operator requirements and/or EGM regulatory requirements. Such a configuration enables the EGM to enter operation quicker (relative to prior EGMs that often entered error states due to conflicting configurations selected the field services technician and/or the operator) while remaining in compliance with operational parameters and/or regulatory standards.

As mentioned above, while generally described in regards to the automatic configuration of an EGM, the above-described embodiments of the present disclosure may be implemented in accordance with or in conjunction with one or more of a variety of different types of gaming devices. The present disclosure contemplates a variety of different gaming devices each having one or more of a plurality of different features, attributes, or characteristics. A “gaming device” as used herein refers to various configurations of: (a) one or more servers; (b) one or more EGMs such as those located on a casino floor; and/or (c) one or more personal gaming devices. Thus, in various embodiments, the gaming device of the present disclosure includes: (a) one or more EGMs in combination with one or more servers; (b) one or more personal gaming devices in combination with one or more servers; (c) one or more personal gaming devices in combination with one or more EGMs; (d) one or more personal gaming devices, one or more EGMs, and one or more servers in combination with one another; (e) a single EGM; (f) a plurality of EGMs in combination with one another; (g) a single personal gaming device; (h) a plurality of personal gaming devices in combination with one another; (i) a single server; and/or (j) a plurality of servers in combination with one another. For brevity and clarity and unless specifically stated otherwise, “EGM” as used herein represents one EGM or a plurality of EGMs, “personal gaming device” as used herein represents one personal gaming device or a plurality of personal gaming devices, and “server” as used herein represents one server or a plurality of servers.

As noted above, in various embodiments, the gaming device comprises an EGM (or personal gaming device) in combination with a server. In such embodiments, the EGM (or personal gaming device) is configured to communicate with the server through a data network or remote communication link. In certain such embodiments, the EGM (or personal gaming device) is configured to communicate with another EGM (or personal gaming device) through the same data network or remote communication link or through a different data network or remote communication link. For example, a gaming establishment includes a plurality of EGMs that are each configured to communicate with a server through a data network.

In certain embodiments in which the gaming device comprises an EGM (or personal gaming device) in combination with a server, the server is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the server. The at least one processor of that EGM (or personal gaming device) is configured to execute the events, messages, or commands represented by such data or signals in conjunction with the operation of the EGM (or personal gaming device). Moreover, the at least one processor of the server is configured to transmit and receive data or signals representing events, messages, commands, or any other suitable information between the server and the EGM (or personal gaming device). The at least one processor of the server is configured to execute the events, messages, or commands represented by such data or signals in conjunction with the operation of the server. One, more than one, or each of the functions of the server may be performed by the at least one processor of the EGM (or personal gaming device). Further, one, more than one, or each of the functions of the at least one processor of the EGM (or personal gaming device) may be performed by the at least one processor of the server.

In certain such embodiments, computerized instructions for controlling any games (such as any primary or base games and/or any secondary or bonus games) displayed by the EGM (or personal gaming device) are executed by the server. In such “thin client” embodiments, the server remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the server to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which a gaming establishment includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming establishment includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming device includes an EGM (or personal gaming device) and a server, computerized instructions for controlling any primary or base games displayed by the EGM (or personal gaming device) are communicated from the server to the EGM (or personal gaming device) in a thick client configuration, and computerized instructions for controlling any secondary or bonus games or other functions displayed by the EGM (or personal gaming device) are executed by the server in a thin client configuration.

In certain embodiments in which the gaming establishment includes: (a) an EGM (or personal gaming device) configured to communicate with a server through a data network; and/or (b) a plurality of EGMs (or personal gaming devices) configured to communicate with one another through a data network, the data network is a local area network (LAN) in which the EGMs (or personal gaming devices) are located substantially proximate to one another and/or the server. In one example, the EGMs (or personal gaming devices) and the server are located in a gaming establishment or a portion of a gaming establishment.

In other embodiments in which the gaming device includes: (a) an EGM (or personal gaming device) configured to communicate with a server through a data network; and/or (b) a plurality of EGMs (or personal gaming devices) configured to communicate with one another through a data network, the data network is a wide area network (WAN) in which one or more of the EGMs (or personal gaming devices) are not necessarily located substantially proximate to another one of the EGMs (or personal gaming devices) and/or the server. For example, one or more of the EGMs (or personal gaming devices) are located: (a) in an area of a gaming establishment different from an area of the gaming establishment in which the server is located; or (b) in a gaming establishment different from the gaming establishment in which the server is located. In another example, the server is not located within a gaming establishment in which the EGMs (or personal gaming devices) are located. In certain embodiments in which the data network is a WAN, the gaming device includes a server and an EGM (or personal gaming device) each located in a different gaming establishment in a same geographic area, such as a same city or a same state. Gaming devices in which the data network is a WAN are substantially identical to gaming devices in which the data network is a LAN, though the quantity of EGMs (or personal gaming devices) in different gaming establishments may vary relative to one another.

In further embodiments in which the gaming device includes: (a) an EGM (or personal gaming device) configured to communicate with a server through a data network; and/or (b) a plurality of EGMs (or personal gaming devices) configured to communicate with one another through a data network, the data network is an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the server identifies a player before enabling that player to place any wagers on any plays of any wagering games. In one example, the server identifies the player by requiring a player account of the player to be logged into via an input of a unique username and password combination assigned to the player. The server may, however, identify the player in any other suitable manner, such as by validating a player tracking identification number associated with the player; by reading a player tracking card or other smart card inserted into a card reader (as described below); by validating a unique player identification number associated with the player by the server; or by identifying the EGM (or personal gaming device), such as by identifying the MAC address or the IP address of the Internet facilitator. In various embodiments, once the server identifies the player, the server enables placement of one or more wagers on one or more plays of one or more primary or base games and/or one or more secondary or bonus games, and displays those plays via the Internet browser of the EGM (or personal gaming device).

The server and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

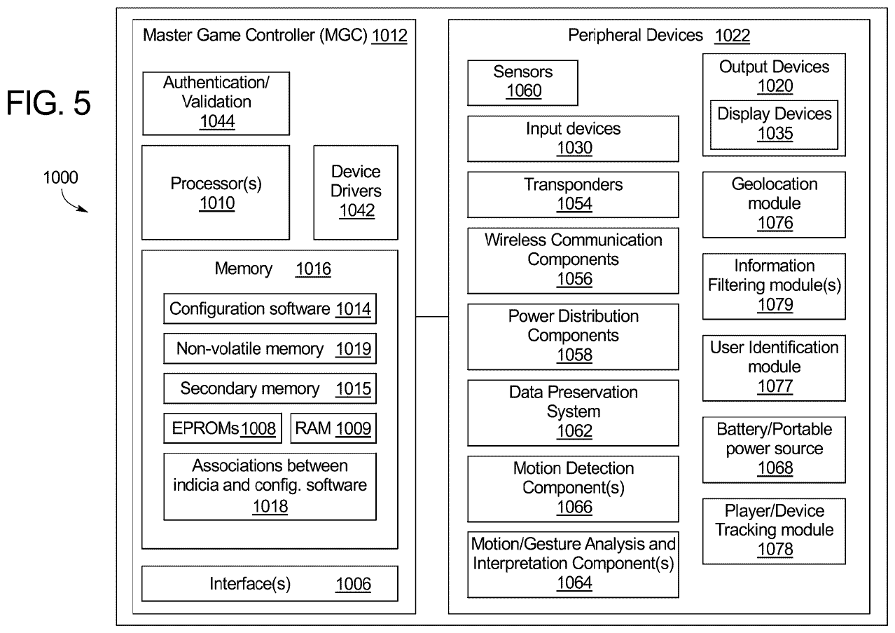

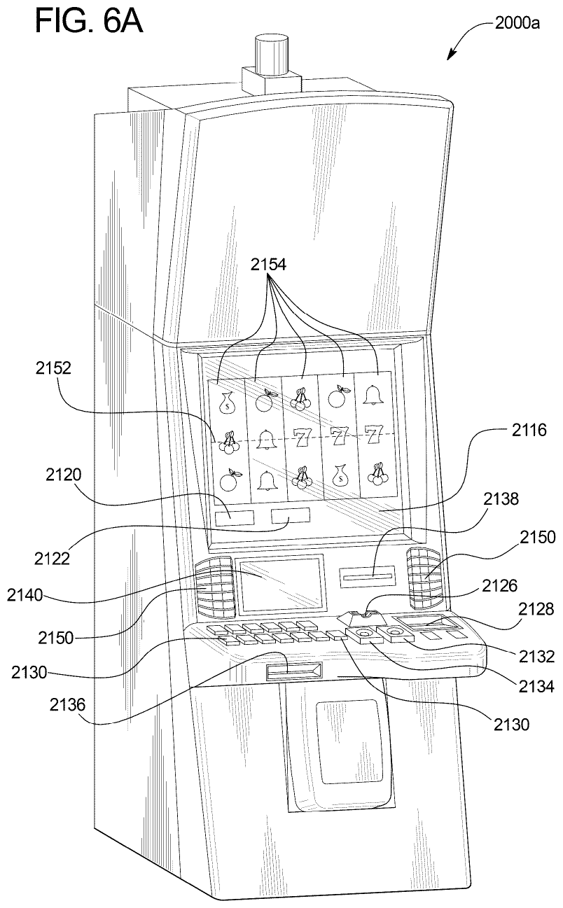

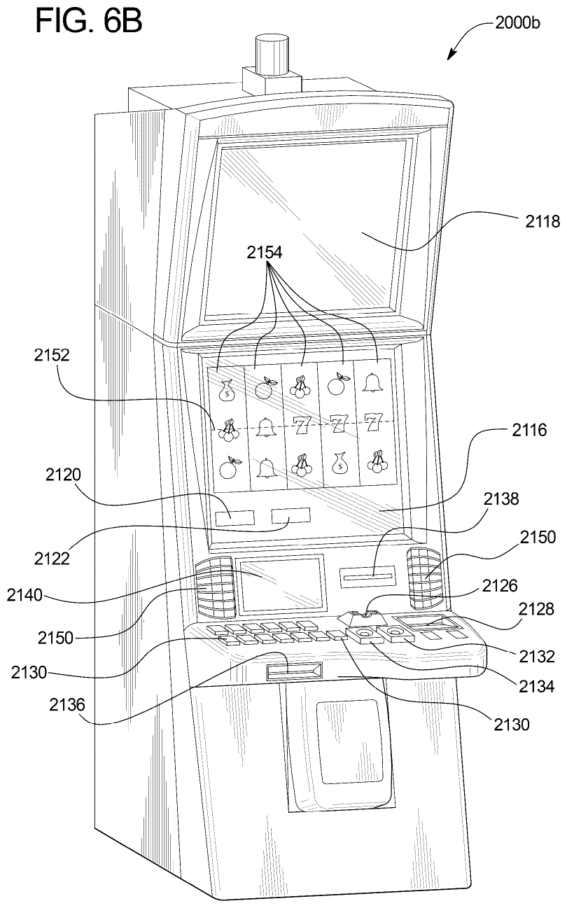

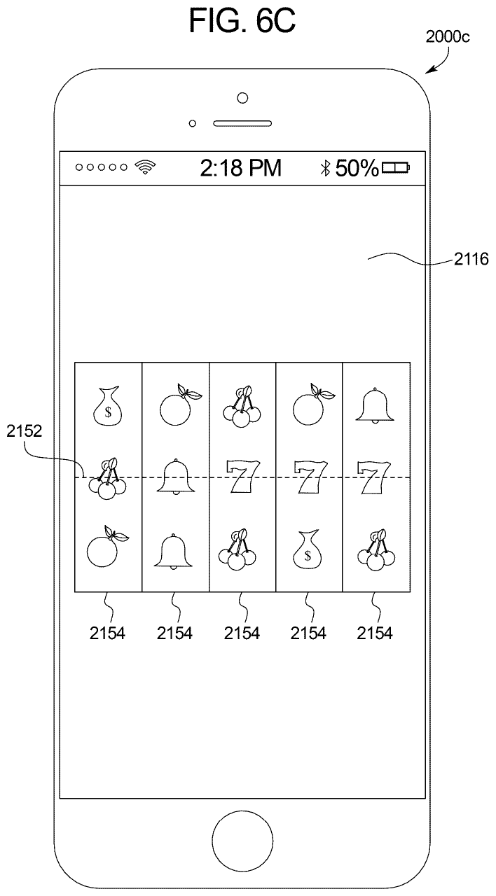

FIG. 5 is a block diagram of an example EGM 1000 and FIGS. 6A and 6B include two different example EGMs 2000a and 2000b. The EGMs 1000, 2000a, and 2000b are merely example EGMs, and different EGMs may be implemented using different combinations of the components shown in the EGMs 1000, 2000a, and 2000b. Although the below refers to EGMs, in various embodiments personal gaming devices (such as personal gaming device 2000c of FIG. 6C) may include some or all of the below components.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM of the present disclosure. In certain embodiments, the at least one memory device 1016 resides within the housing of the EGM (described below), while in other embodiments at least one component of the at least one memory device 1016 resides outside of the housing of the EGM. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth™, near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, user input device components, information received from one or more user input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one user identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 6A includes a central display device 2116, a player tracking display 2140, a credit display 2120, and a bet display 2122. The example EGM 2000b illustrated in FIG. 6B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 6A and 6B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 6A and 6B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 6A and 6B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 6A and 6B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 6A and 6B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 6A and 6B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 6A and 6B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth™); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more user input devices near the EGM. In one embodiment, a user input device docking region is provided, and includes a power distribution component that is configured to recharge a user input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., user input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one user identification module 1077 is configured to determine the identity of the current user or current owner of the EGM. For example, in one embodiment, the current user is required to perform a login process at the EGM in order to access one or more features. Alternatively, the EGM is configured to automatically determine the identity of the current user based on one or more external signals, such as an RFID tag or badge worn by the current user and that provides a wireless signal to the EGM that is used to determine the identity of the current user. In at least one embodiment, various security features are incorporated into the EGM to prevent unauthorized users from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 6A and 6B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 6A and 6B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all gaming devices, and these example EGMs may not include one or more elements that are included in other gaming devices. For example, certain EGMs include a coin acceptor while others do not.

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as “primary games”) and/or any secondary or bonus games or other functions (referred to herein as “secondary games”) displayed by the EGM are provided with the EGM before delivery to a gaming establishment or before being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the gaming device includes a server and a changeable EGM, the at least one memory device of the server stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the server is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the server to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the gaming device randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming device generates the game outcome(s) and/or the award(s) to be provided based on the associated probabilities. In these embodiments, since the gaming device generates game outcomes and/or awards randomly or based on one or more probability calculations, there is no certainty that the gaming device will ever provide any specific game outcome and/or award.

In certain embodiments, the gaming device maintains one or more predetermined pools or sets of predetermined game outcomes and/or awards. In certain such embodiments, upon generation or receipt of a game outcome and/or award request, the gaming device independently selects one of the predetermined game outcomes and/or awards from the one or more pools or sets. The gaming device flags or marks the selected game outcome and/or award as used. Once a game outcome or an award is flagged as used, it is prevented from further selection from its respective pool or set; that is, the gaming device does not select that game outcome or award upon another game outcome and/or award request. The gaming device provides the selected game outcome and/or award.

In certain embodiments, the gaming device determines a predetermined game outcome and/or award based on the results of a bingo, keno, or lottery game. In certain such embodiments, the gaming device utilizes one or more bingo, keno, or lottery games to determine the predetermined game outcome and/or award provided for a primary game and/or a secondary game. The gaming device is provided or associated with a bingo card. Each bingo card consists of a matrix or array of elements, wherein each element is designated with separate indicia. After a bingo card is provided, the gaming device randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the gaming device includes a server and an EGM, the EGM is configured to communicate with the server for monitoring purposes only. In such embodiments, the EGM determines the game outcome(s) and/or award(s) to be provided in any of the manners described above, and the server monitors the activities and events occurring on the EGM. In one such embodiment, the gaming device includes a real-time or online accounting and gaming information system configured to communicate with the server. In this embodiment, the accounting and gaming information system includes: (a) a player database configured to store player profiles, (b) a player tracking module configured to track players (as described below), and (c) a credit system configured to provide automated transactions.

As noted above, in various embodiments, the gaming device includes one or more executable game programs executable by at least one processor of the gaming device to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the gaming device includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the gaming device. In certain such embodiments, the gaming device includes one or more paylines associated with the reels. The example EGM 2000b shown in FIG. 6B includes a payline 1152 and a plurality of reels 1154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The gaming device enables a wager to be placed on one or more of such paylines to activate such paylines. In other embodiments in which one or more paylines are formed between at least two adjacent symbol display areas, the gaming device enables a wager to be placed on a plurality of symbol display areas, which activates those symbol display areas.

In various embodiments, the gaming device provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the gaming device employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, the gaming device includes a progressive award. Typically, a progressive award includes an initial amount and an additional amount funded through a portion of each wager placed to initiate a play of a primary game. When one or more triggering events occurs, the gaming device provides at least a portion of the progressive award. After the gaming device provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the gaming device provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the gaming device automatically provides or initiates the secondary game upon the occurrence of a triggering event or the satisfaction of a qualifying condition. In other embodiments, the gaming device initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the gaming device randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the gaming device determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the gaming establishment includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the gaming establishment includes one or more player tracking systems. Such player tracking systems enable operators of the gaming device (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming device to begin a gaming session, the card reader reads the player identification number off the player tracking card to identify the player. The gaming device timely tracks any suitable information or data relating to the identified player's gaming session. The gaming device also timely tracks when the player tracking card is removed to conclude play for that gaming session. In another embodiment, rather than requiring insertion of a player tracking card into the card reader, the gaming device utilizes one or more portable devices, such as a mobile phone, a radio frequency identification tag, or any other suitable wireless device, to track when a gaming session begins and ends. In another embodiment, the gaming device utilizes any suitable biometric technology or ticket technology to track when a gaming session begins and ends.

In such embodiments, during one or more gaming sessions, the gaming device tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

In various embodiments, the gaming establishment includes one or more servers configured to communicate with a personal gaming device—such as a smartphone, a tablet computer, a desktop computer, or a laptop computer—to enable web-based game play using the personal gaming device. In various embodiments, the player must first access a gaming website via an Internet browser of the personal gaming device or execute an application (commonly called an “app”) installed on the personal gaming device before the player can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the player before enabling game play on the personal gaming device (or, in some embodiments, before enabling monetary wager-based game play on the personal gaming device). In these embodiments, the player must identify herself to the one or more servers, such as by inputting the player's unique username and password combination, providing an input to a biometric sensor (e.g., a fingerprint sensor, a retinal sensor, a voice sensor, or a facial-recognition sensor), or providing any other suitable information.

Once identified, the one or more servers enable the player to establish an account balance from which the player can draw credits usable to wager on plays of a game. In certain embodiments, the one or more servers enable the player to initiate an electronic funds transfer to transfer funds from a bank account to the player's account balance. In other embodiments, the one or more servers enable the player to make a payment using the player's credit card, debit card, or other suitable device to add money to the player's account balance. In other embodiments, the one or more servers enable the player to add money to the player's account balance via a peer-to-peer type application, such as PayPal or Venmo. The one or more servers also enable the player to cash out the player's account balance (or part of it) in any suitable manner, such as via an electronic funds transfer, by initiating creation of a paper check that is mailed to the player, or by initiating printing of a voucher at a kiosk in a gaming establishment.

In certain embodiments, the one or more servers include a payment server that handles establishing and cashing out players'account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the player's account balance can cover the desired wager (i.e., includes a monetary balance at least equal to the desired wager).

If the payment server determines that the player's account balance cannot cover the desired wager, the payment server notifies the game server, which then instructs the personal gaming device to display a suitable notification to the player that the player's account balance is too low to place the desired wager. If the payment server determines that the player's account balance can cover the desired wager, the payment server deducts the desired wager from the account balance and notifies the game server. The game server then determines an outcome and any associated award for the play of the game. The game server notifies the payment server of any nonzero award, and the payment server increases the player's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines or within the boundaries of a gaming establishment). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the gaming device comprises an EGM configured to communicate with a personal gaming device—such as a smartphone, a tablet computer, a desktop computer, or a laptop computer—to enable tethered mobile game play using the personal gaming device. Generally, in these embodiments, the EGM establishes communication with the personal gaming device and enables the player to play games on the EGM remotely via the personal gaming device. In certain embodiments, the gaming device includes a geo-fence system that enables tethered game play within a particular geographic area but not outside of that geographic area.

In certain embodiments, the gaming device is configured to communicate with a social network server that hosts or partially hosts a social networking website via a data network (such as the Internet) to integrate a player's gaming experience with the player's social networking account. This enables the gaming device to send certain information to the social network server that the social network server can use to create content (such as text, an image, and/or a video) and post it to the player's wall, newsfeed, or similar area of the social networking website accessible by the player's connections (and in certain cases the public) such that the player's connections can view that information. This also enables the gaming device to receive certain information from the social network server, such as the player's likes or dislikes or the player's list of connections. In certain embodiments, the gaming device enables the player to link the player's player account to the player's social networking account(s). This enables the gaming device to, once it identifies the player and initiates a gaming session (such as via the player logging in to a website (or an application) on the player's personal gaming device or via the player inserting the player's player tracking card into an EGM), link that gaming session to the player's social networking account(s). In other embodiments, the gaming device enables the player to link the player's social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the gaming device sends information about the award to the social network server to enable the server to create associated content (such as a screenshot of the outcome and associated award) and to post that content to the player's wall (or other suitable area) of the social networking website for the player's connections to see (and to entice them to play). In another embodiment, if a player joins a multiplayer game and there is another seat available, the gaming device sends that information to the social network sever to enable the server to create associated content (such as text indicating a vacancy for that particular game) and to post that content to the player's wall (or other suitable area) of the social networking website for the player's connections to see (and to entice them to fill the vacancy). In another embodiment, if the player consents, the gaming device sends advertisement information or offer information to the social network server to enable the social network server to create associated content (such as text or an image reflecting an advertisement and/or an offer) and to post that content to the player's wall (or other suitable area) of the social networking website for the player's connections to see. In another embodiment, the gaming device enables the player to recommend a game to the player's connections by posting a recommendation to the player's wall (or other suitable area) of the social networking website.

Certain of the gaming devices described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general-purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general-purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general-purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general-purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general-purpose computing device.

A second difference between EGMs and general-purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general-purpose computing devices (and as described in more detail above) is authentication—EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general-purpose computing devices is that EGMs have unique peripheral device requirements that differ from those of a general-purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general-purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as “fault-tolerant” memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the “standard” EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third-party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., “unalterable memory”) such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general-purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

It should be appreciated that the terminology used herein is for the purpose of describing particular aspects only and is not intended to be limiting of the disclosure. For example, the singular forms “a”, “an” and “the” are intended to include the plural forms as well, unless the context clearly indicates otherwise. In another example, the terms “including” and “comprising” and variations thereof, when used in this specification, specify the presence of stated features, steps, operations, elements, and/or components, but do not preclude the presence or addition of one or more other features, steps, operations, elements, components, and/or groups thereof. Additionally, a listing of items does not imply that any or all of the items are mutually exclusive nor does a listing of items imply that any or all of the items are collectively exhaustive of anything or in a particular order, unless expressly specified otherwise. Moreover, as used herein, the term “and/or” includes any and all combinations of one or more of the associated listed items. It should be further appreciated that headings of sections provided in this document and the title are for convenience only, and are not to be taken as limiting the disclosure in any way. Furthermore, unless expressly specified otherwise, devices that are in communication with each other need not be in continuous communication with each other and may communicate directly or indirectly through one or more intermediaries.

Various changes and modifications to the present embodiments described herein will be apparent to those skilled in the art. For example, a description of an embodiment with several components in communication with each other does not imply that all such components are required, or that each of the disclosed components must communicate with every other component. On the contrary a variety of optional components are described to illustrate the wide variety of possible embodiments of the present disclosure. For example, while certain processes are represented by a set of instructions stored in one or more memories and executed by one or more processors, many other processes of performing the acts associated with this illustrated processes may be employed and the order of certain processes may be changed, may be optional or may not be employed. As such, certain changes and modifications can be made without departing from the spirit and scope of the present subject matter and without diminishing its intended technical scope. It is therefore intended that such changes and modifications be covered by the appended claims.

The invention is claimed as follows:

1. A system comprising:
a processor; and
a memory device that stores a plurality of instructions that, when executed by the processor responsive to an occurrence of a configuration event, cause the processor to:
determine a current configuration of an electronic gaming machine,
generate, at least partially based on the current configuration of the electronic gaming machine, a plurality of configuration scripts associated with a plurality of automatic configurations of the electronic gaming machine, and
cause a delivery of the generated plurality of configuration scripts.

2. The system of claim 1, wherein at least one of the plurality of configuration scripts is mandatorily applied to automatically configure a first setting of the electronic gaming machine.

3. The system of claim 2, wherein the first setting of the electronic gaming machine is associated with each electronic gaming machine of a gaming establishment.

4. The system of claim 2, wherein at least one of the plurality of configuration scripts is optionally applied to automatically configure a second setting of the electronic gaming machine.

5. The system of claim 2, wherein a second setting of the electronic gaming machine is manually applied.

6. The system of claim 1, wherein at least one of the plurality of configuration scripts is optionally applied to automatically configure a game software program of the electronic gaming machine.

7. The system of claim 1, wherein the plurality of configuration scripts are arranged as a plurality of layers.

8. The system of claim 7, wherein one configuration script per layer is applicable to automatically configure the electronic gaming machine.

9. The system of claim 1, wherein at least one of the plurality of configuration scripts is at least partially based on at least one of an operational parameter associated with an electronic gaming machine supplier, an operational parameter associated with an electronic gaming machine operator, and an operational parameter associated with an electronic gaming machine regulator.

10. A configuration script generator comprising:
a processor; and
a memory device that stores a plurality of instructions that, when executed by the processor, cause the processor to:
receive first data associated with a current configuration of software packages of an electronic gaming machine,
receive second data associated with at least one of a first operational parameter associated with an electronic gaming machine supplier, and a second operational parameter associated with an electronic gaming machine operator,
generate, at least partially based on the received first data and the received second data, a plurality of layered configuration scripts that are each associated with different automatic modification of at least one of the software packages of the electronic gaming machine, and
cause a delivery of the generated plurality of layered configuration scripts.

11. The configuration script generator of claim 10, wherein at least one of the plurality of layered configuration scripts is mandatorily applied to automatically configure at least one of the software packages of the electronic gaming machine and at least one of the plurality of layered configuration scripts is optionally applied to automatically configure at least another one of the software packages of the electronic gaming machine.

12. A method of operating a system, the method comprising:
responsive to an occurrence of a configuration event:
determining, by a processor, a current configuration of an electronic gaming machine,
generating, by the processor and at least partially based on the current configuration of the electronic gaming machine, a plurality of configuration scripts associated with a plurality of automatic configurations of the electronic gaming machine, and
causing a delivery of the generated plurality of configuration scripts.

13. The method of claim 12, wherein at least one of the plurality of configuration scripts is mandatorily applied to automatically configure a first setting of the electronic gaming machine.

14. The method of claim 13, wherein the first setting of the electronic gaming machine is associated with each electronic gaming machine of a gaming establishment.

15. The method of claim 13, wherein at least one of the plurality of configuration scripts is optionally applied to automatically configure a second setting of the electronic gaming machine.

16. The method of claim 13, wherein a second setting of the electronic gaming machine is manually applied.

17. The method of claim 12, wherein at least one of the plurality of configuration scripts is optionally applied to automatically configure a game software program of the electronic gaming machine.

18. The method of claim 12, wherein the plurality of configuration scripts are arranged as a plurality of layers.

19. The method of claim 18, wherein one configuration script per layer is applicable to automatically configure the electronic gaming machine.

20. The method of claim 12, wherein at least one of the plurality of configuration scripts is at least partially based on at least one of an operational parameter associated with an electronic gaming machine supplier, an operational parameter associated with an electronic gaming machine operator, and an operational parameter associated with an electronic gaming machine regulator.
